(19) United States
(12) Patent Application Publication
(10) Pub. No.: US 2025/0114706 A1
(43) Pub. Date: Apr. 10, 2025

(54) VIRTUAL ENVIRONMENT AUGMENTATION METHODS AND SYSTEMS

(71) Applicant: Sony Interactive Entertainment Inc., Tokyo (JP)

(72) Inventors: Maria Chiara Monti, London (GB); Pierluigi Vito Amadori, London (GB)

(73) Assignee: Sony Interactive Entertainment Inc., Tokyo (JP)

(21) Appl. No.: 18/892,669

(22) Filed: Sep. 23, 2024

(30) Foreign Application Priority Data
Oct. 4, 2023 (GB) 2315224.2

(51) Int. Cl. A63F 13/56; A63F 13/21; A63F 13/65

(52) U.S. Cl. CPC A63F 13/56; A63F 13/21; A63F 13/65; A63F 2300/8082

(57) ABSTRACT

There is provided a method for augmenting a virtual environment. The method comprises identifying one or more actions of one or more non-users in a real environment of a user who is interacting with a virtual environment, in dependence on data relating to the non-users captured using one or more sensors, characterising the one or more identified actions of the non-users relative to one or more corresponding reference actions, and modifying an aspect of behaviour of one or more characters in the virtual environment that are not controlled by the user, in dependence on the characterisation of the one or more identified actions of the non-users.

### BACKGROUND OF THE INVENTION

### Field of the invention

The present invention relates to a method and system for augmenting a virtual environment.

### Description of the Prior Art

Modern virtual environments (e.g. those of videogames) are often very complex and feature rich, and the creation of such environment can be very computationally expensive as well as time-consuming for developers. Virtual environments often include a large number of characters (such as user- or computer-controlled characters), and in some cases creation and scripting of these characters can be one of the most challenging and computationally intensive aspects of the creation of a virtual environment. Nonetheless, despite significant amounts of time and resources being dedicated to the creation of virtual environments and their characters, these environments are often tailored for a particular target group of users, while other users may find such environments less intuitive and immersive.

To address this issue, it is known to adapt virtual environments, such as the dialogue or visual parts of an environment, for different groups of users—such as for users in different countries. However, this process is frequently complex and has a high associated computational cost. Further, a virtual environment adapted in this way is likewise typically tailored for a given group of users, so several separate adaptions may be required to provide virtual environments well suited to different groups of users. This can result in further increases in computational resource usage.

A further known approach is to provide user-customisable virtual environments. For example, users may be able to select various settings for the virtual environment, such as a colour scheme for the environment or the appearance of characters in the environment, in advance of interacting with the environment. However, the process of such customisation is often cumbersome and time consuming for users. Further, the degree to which users are able to customise their virtual environment is typically restricted, and it may not be possible for users to customise an environment to the extent that it is well suited to their needs.

The present invention seeks to mitigate or alleviate these problems, and to provide more efficient virtual environment augmentation techniques.

### SUMMARY OF THE INVENTION

Various aspects and features of the present invention are defined in the appended claims and within the text of the accompanying description and include at least:

In a first aspect, a method for augmenting a virtual environment is provided in accordance with claim 1.

In another aspect, a system for augmenting a virtual environment is provided in accordance with claim 15.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an entertainment device;

FIG. 2 is a schematic flowchart illustrating a method of augmenting a virtual environment; and

FIG. 3 schematically illustrates a system for augmenting a virtual environment.

### DESCRIPTION OF THE EMBODIMENTS

A method and system for augmenting a virtual environment are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In an example embodiment of the present invention, a suitable system and/or platform for implementing the methods and techniques herein may be an entertainment system.

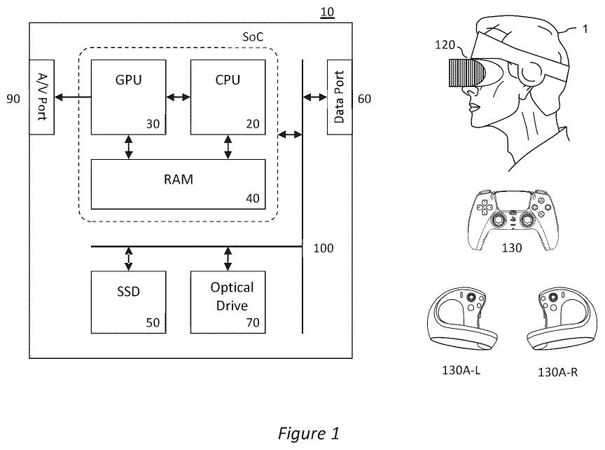

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD. The user typically interacts with the system, and any content displayed by, or virtual environment rendered by the system, by providing inputs via the handheld controllers 130, 130A. For example, when playing a game, the user may navigate around the game virtual environment by providing inputs using the handheld controllers 130, 130A.

In embodiments of the present disclosure, the entertainment device 10 generates one or more images of a virtual environment for display (e.g. via a television or the HMD 120). Alternatively, or in addition, the entertainment device 10 may generate sound associated with the virtual environment for output to a user (e.g. via loudspeakers on a television or the HMD 120).

Embodiments of the present disclosure relate to augmenting a virtual environment for a user by identifying actions of non-users in the real environment of the user (e.g. friends sharing a room with the user) and modifying an aspect of behaviour of characters in the virtual environment that are not controlled by the user (e.g. computer-controlled characters or characters controlled by other users) in dependence on a characterisation of the identified actions of the non-users relative to corresponding reference actions (e.g. modifying the characters' accent based on a characterisation of the non-users' pronunciation of a given word relative to a reference pronunciation). This allows enriching the virtual environment for the user, while also not requiring explicit scripting of the characters' behaviour by a developer. Thus, a richer and more immersive virtual environment can be provided in an automated way for a wide range of different users (each of which may typically interact with different non-users) in an efficient manner.

The present disclosure may provide a form of behavioural style transfer from people in the real environment of the user to characters in a virtual environment. This enables a more natural experience of the virtual world for the user as characters behave in a manner consistent with a user's normal experience of interacting with people. This also improves accessibility of the virtual environment for the user as characters behave in a way that is familiar for the user (e.g. use gestures and accents consistent with the user's background) and so interactions with the characters can be more intuitive and easier to understand for the user.

The present disclosure is particularly applicable to augmenting videogame virtual environments. Interactions with other characters in the game often form a key part of a user's experience of playing a videogame, and videogames are often played by a wide variety of users each of which may normally interact with other groups of people. Thus, by allowing the importing of behaviour characteristics (e.g. mannerisms) of people from users' real environments into the videogame, a more personalised and immersive experience can be provided for each user, without requiring a videogame developer to explicitly adapt the game for each user.

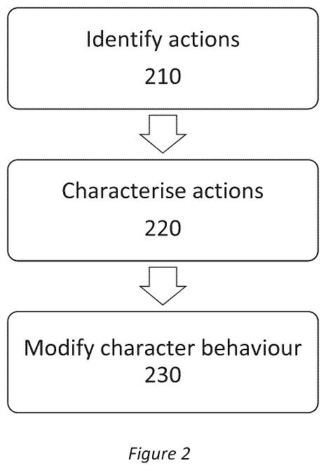

FIG. 2 shows an example of a method for augmenting a virtual environment in accordance with one or more embodiments of the present disclosure.

For the purposes of explanation, a non-limiting example of the disclosure may be illustrated with reference to a user playing a videogame. The videogame has an associated virtual environment which in turn comprises a character (i.e. avatar) controlled by the user and one or more further characters that are not controlled by the user, such as computer-controlled characters (e.g. non-player characters, NPCs) or characters controlled by other users.

A step 210 comprises identifying one or more actions of one or more non-users in a real environment of a user who is interacting with a virtual environment.

As used herein, the term “non-user” preferably connotes a person who is not using or interacting with the virtual environment, and who is not controlling any characters in the virtual environment. This contrasts with a “user” who is interacting with the virtual environment and may control a character in the environment, e.g. to cause the character to move around the environment or interact with various objects or other characters in the environment.

As used herein, the term “real environment” preferably connotes the physical environment of the user while they are interacting with the virtual environment. For example, the real environment of a user may comprise the room that the user is in while interacting with the environment (e.g. playing a videogame), such as the living room of the user's house.

Thus, for example, non-users in a real environment of a user may include people in the vicinity of the user, such as people who are actively spectating the user interacting with the virtual environment (e.g. on a television to which the virtual environment is output), or people who are simply in the same room but may be primarily engaging in other activities (e.g. people reading a book while sitting on the sofa next to the user).

It will be appreciated that the real environment as well as non-users in the real environment may change between, or during, sessions of the user's interactions with the environment. For example, the user may move between rooms between or during a game session, and various non-user people may come in and out of the room in which the user is playing a game over the course of a game session.

Step 210 comprises identifying actions of these non-users in the real environment of the user. It will be appreciated that the term “action” as used herein may relate to any form of behaviour of a non-user, including a position or movement of their body, as well as their speech. For example, an action may comprise one or more of: vocalisations of the non-user, gestures of the non-user, facial expressions of the non-user, posture of the non-user, and/or words spoken by the non-user.

The actions of the non-users are identified in dependence on data relating to the non-users captured using one or more sensors. This data may for example comprise audio, video, and/or motion data; and the one or more sensors may comprise one or more image sensors (e.g. cameras), audio sensors (e.g. microphones), and/or motion sensors (e.g. inertial measurement units, IMUs).

In one or more examples, the one or more sensors may be provided on peripherals of the entertainment device 10 and/or separate devices that interact with the entertainment device.

Hence data relating to the non-users may be received from one or more peripherals of the entertainment device, or devices interacting with the entertainment device (e.g. via the Internet). These may include for example for the purposes of audio a microphone (for example a standalone microphone connected to the entertainment device, a microphone on a videogame controller 130, or a microphone on a mobile phone wirelessly coupled to the entertainment device either directly, via a home network, or via the Internet). For the purposes of video, a video camera or other camera (again similarly for example on the mobile phone). For the purposes of gesticulation, any suitable device comprising an accelerometer or other motion detection technique such as again a mobile phone, or suitable analysis of captured video.

This data may be captured passively, without requiring operation by the user or non-users. Alternatively, or in addition, non-users may input the data themselves, for example by providing suitable audio and/or video recordings (e.g. using their mobile phones).

It will be appreciated that the one or more sensors are arranged to capture data relating to the non-users in addition to, or instead of, capturing data relating to the user. Arranging the sensors in this way may include selecting appropriate positions and/or settings for the sensors. For example, for image sensors, a wide angle video camera may be provided adjacent a display (e.g. television) in order to capture data relating to non-users sharing a room with the user. Similarly, for sound sensors, the sensitivity and/or directivity of a microphone may be adjusted in order capture speech of non-users in the room. For motion sensors, appropriate device including the sensors may be selected to capture data relating to the non-users—e.g. a mobile phone of a non-user may be used to capture motion data relating to that non-user.

It will also be appreciated that in cases where the captured data also comprises data relating to the user (who is interacting with the virtual environment), one or more processing steps may be applied to the captured data to remove (e.g. filter out) data relating to the user, such that only data relating to the non-users is analysed to identify their actions. The way in which this data relating to the user is removed from the captured data may depend on the type of captured data. For example, for video data, the user may be identified in captured video (e.g. based on which person is holding a peripheral such as the controller 130 or HMD 120, or based on facial recognition) and video of that user may be ignored when identifying non-user actions at step 210. Similarly, for audio data, speech of the user may be identified in the captured audio—for example, based on characteristics of the user's voice (which may e.g. be obtained as part of an initial calibration), or based on relative volume of received sound (e.g. for a microphone provided at a peripheral used by the user, the loudest sound may be associated with the user while sounds of lower volume may be associated with non-users in the same room). Speech of the user may then be filtered out from the captured audio using appropriate signal processing techniques.

Data relating to the non-users captured using the one or more sensors (e.g. provided as part of peripherals as described above) may then be analysed to identify one or more actions of the non-users.

For voice input data (for example captured by microphone as an audio only input or as part of a video input) one or more different analyses may be performed.

For example, speech to text processing may be performed to provide text for content analysis as described later herein.

Alternatively, or in addition, voice analysis based on properties such as volume, pitch, speed, tremble/tremolo and the like may be performed, e.g. to then, at step 220, determine a non-user's accent or any other sound characteristic to the non-user (e.g. the sound they make to express sentiment or emotion such as anger, joy, fear, sadness and the like) as described later herein. In some cases, frequency analysis may be performed on the voice input data.

For video input data again one or more different analyses may be performed.

For example, facial analysis may be performed to recognise a facial expression of a non-user, such as pursing lips, frowning and the like.

Alternatively, or in addition, gestural analysis may be performed to identify gestures of a non-user (such as waving hands) or a posture of a non-user (e.g. slouching).

For accelerometer/motion input data, similar gestural analysis may be performed.

One or more of such inputs (e.g. voice tone, spoken words, facial expression, body language, gesture) may be used as inputs to an action identification system. The action identification system may comprise a trained machine learning model (e.g. neural network) which has been trained to identify actions of non-users based on input captured data relating to the non-users. The machine learning model may for example be trained using supervised learning based on a labelled dataset of captured data and identified actions.

The action identification system may be configured (e.g. by suitable software instructions) to identify various types of actions. These types of actions may include one or more of: characteristic actions, reactive actions, auxiliary actions, and/or repetitive actions. The same machine learning model may be used to identify each of these types of actions. Alternatively, separate machine learning models trained to detect a particular type of action may be used for each type of action.

Considering characteristic actions, identifying these actions may comprise identifying performances of one or more predefined actions by a non-user so that these can then be compared to corresponding reference actions. This can allow identifying characterising traits of the non-users so that they can be imported into the virtual environment. For example, usage of specific predefined words (e.g. “world”, or “school”) by a non-user may be identified so that their pronunciation can then be compared to reference pronunciations of those words at step 220 in order to determine an accent of the non-user. Alternatively, or in addition, the action of walking (or sitting) by a non-user may be identified so that this can be compared to reference walking patterns to identify a characteristic gait (or sitting position) of the non-user. In a similar way, a general posture or facial expression of a non-user may be identified.

In some cases, the captured data may be analysed to identify typical modes of communication and/or movement of the non-users. For example, use of sign language or walking aids (e.g. a wheelchair or cane) by non-users in the user's real environment may be identified. Importing these modes for characters in the virtual environment as described later herein can improve the accessibility and inclusivity of the virtual environment in an efficient manner as this can be achieved without specific developer or user input.

Considering reactive actions, identifying such actions may comprise identifying a reaction of a non-user to an event in the virtual and/or real environment-in other words, identifying actions triggered by events. Example events in the virtual environment may for example comprise a success or failure event in the user's interaction (e.g. completing a mission in a videogame, or dying while trying to complete the mission), or an event that is expected to solicit specific reactions of spectating people (e.g. a scary scene in the virtual environment, such as zombies suddenly attacking the user's avatar). Example events in the real environment may for example comprise a loud sound (e.g. a sound with a volume exceeding a predetermined threshold, such as a sound caused by an object being dropped on the ground, or thunder which may cause a reaction of being scared or startled).

Sensor data captured during and/or after these events may be analysed to identify reactions of non-users to these events. For example, the reactions of non-users to a user success in the interaction, such as clapping, cheering or specific words being spoken by the non-users, may indicate how the non-users celebrate and characters in the virtual environment may be caused to celebrate in a similar way at step 230. Similarly, the reactions of non-users to a user failure in the interaction, e.g. dropping of shoulders, or specific words being spoken by the non-users, may indicate how the non-users express disappointment and characters in the virtual environment may be caused to express disappointment in a similar way. Again similarly, the reactions of non-users to scary scenes in the virtual environment or loud sounds in the real environment, such as jumping up, screaming or specific words being spoken by the non-users, may indicate how the non-users express being scared and characters in the virtual environment may be caused to react in a similar way.

Considering auxiliary actions, identifying actions of the non-users may comprise identifying a first (i.e. ‘main’) action of a non-user that is performed at least partially simultaneously with a second (i.e. ‘auxiliary’) action of the non-user—in other words, identifying a pair of at least partially overlapping actions of a non-user. For example, non-users may perform certain characteristic actions while they perform other actions, such as gesturing while speaking, either in general or using specific gestures (e.g. waving their arms), or tilting their head while speaking. These pairs of actions may be identified by considering main and auxiliary actions in this way, so that when characters in the virtual environment perform a main action they can also be caused to perform the corresponding auxiliary action identified for a non-user. For example, a computer-controlled character may be caused to gesture while talking at step 230.

In some cases, data captured using a plurality of sensors may be used to identify auxiliary actions. For example, audio data may be used to identify a main action of speaking by a non-user and video data and/or motion data (e.g. captured using a non-user's mobile phone or smartwatch) may be used to identify the corresponding auxiliary action of hand gestures.

Considering repetitive actions, identifying actions of the non-users may comprise identifying an action of a non-user that is repeated a plurality of (e.g. at least a predetermined number of) times by the non-user. This allows identifying characteristic actions of non-users that they often repeat. The actions whose repetition is monitored may be predefined—for example, a predefined set of actions that non-users may repeat may be defined and a counter may be used to count the number of times these are repeated by non-users. This predefined set of actions may for example comprise common tics, such as a person shaking their head, moving their jaw or blinking repeatedly; or commonly repeated phrases or words such as filler words (e.g. “like”, “um”, “uh”, “you know”, “well”) or words commonly used to address other people (e.g. “mate”, or “bro”). A repetitive action may be identified when the counter exceeds a predetermined threshold. A different threshold may be used for different actions—e.g. a lower threshold may be used for tics than for words. Alternatively or in addition to using thresholds, repetitive actions may be identified based on relative frequencies of repletion of different actions—e.g. a given number (e.g. 3 or 5) actions that are repeated most frequently by a non-user may be identified as repetitive actions for that non-user. In some cases, a minimum threshold of repetition may also be used.

Alternatively, or in addition to monitoring for predefined actions, a list of actions whose repetition is being monitored may be built up during the monitoring process (i.e. as the data is being captured). For example, speech to text analysis may be applied to sound inputs from non-users and counters may be kept for the repetition of each word used by the non-users. Repetitive actions may then be identified based on predetermined thresholds or relative frequencies of repetition as described above.

In some cases, actions of non-users may be identified in dependence on one or more properties of the user. Properties of the user may for example be obtained from a user profile associated with the user. Example relevant properties may include the user's nationality, gender, age, or level in an application (e.g. videogame) associated with the virtual environment. The system may have predefined mappings of different expected actions of non-users in the real environment of the user in dependence on these user properties. For example, different words or gestures commonly used by non-users may be expected for different demographics of users. The system may then use different models (e.g. different machine learning models) to identify actions of non-users in dependence on properties of the user—for example, different models may be fine-tuned for detection of different actions that are expected for given user properties. In some cases, multiple of such different models may be used for non-users in the real environment of a given user (e.g. a teenager) as different demographics of non-users (e.g. a younger group of friends and older group of parents) may be expected to be in the real environment of the given user.

In some cases, step 210 may comprise identifying actions of non-users in real environments of one or more further users interacting with the virtual environment, in dependence on data relating to the respective non-users captured using one or more respective sensors. The actions of non-users in the real environment of each user may be identified using the above described techniques. Considering actions of non-users in the vicinity of multiple users in this way can provide a larger data set comprising a more varied set of behaviours representative of a larger group that may be associated with the ‘main’ user (in who's virtual environment the behaviour of characters is modified at step 230), thus allowing further enriching the main user's virtual environment. The one or more further users may be selected in dependence on one or more properties of the user. For example, the further users may be selected as members of the same team in the virtual environment (e.g. a team of players in a videogame) as the user. This allows personalising the experience of the user in dependence on the way in which non-users associated with users who are likely to be associates of the user behave.

Alternatively, or in addition, the further users may be categorised based on various other properties of the user such as their nationality, spoken language, location, gender, or age, so as to select further users that interact with similar non-users as the main user. This allows identifying more general behaviour trends or mannerisms for groups of users, such as user of a given nationality (e.g. Italians), so that these can be applied to characters in the virtual environment to provide a richer and more familiar experience for the user.

In this way, the present disclosure can provide an efficient way to implement content localisation, where content and virtual environments can be adapted for users in different countries. For example, by considering actions of non-users in a plurality of real environments in a particular geographical region (for instance, based upon a user's IP address, location tracking data, and/or user profile), modifications to behaviour of characters may be determined so that these can be applied for all users in that geographical region, all while not requiring specific scripting by developers or specific user customisations. Geographical regions may be determined freely, by a content developer or on a per-user basis; they may correspond to nations, counties, cities, or any other area.

It will be appreciated that a given real environment may comprise a plurality of users (e.g. a plurality of users playing the same or different games in the same room). The same non-users may be considered for each of such users. Alternatively, a subset of non-users may be considered for each user—for example, the non-users most proximate to each user may be considered in determining the modifications to characters' behaviour for that user.

In this way, using one or more of the above techniques, various actions of the non-users may be identified based on the captured data at step 210. As described above, these identified actions may for example include vocalisations (e.g. a vocalisation (e.g. scream) celebrating the user's success in a scenario in the virtual environment, or a particular characteristic tone of voice), gestures (e.g. hand gesturing while talking), facial expressions (e.g. frowning), posture (e.g. slouching), and/or words spoken by the non-user (e.g. repeated use of the words “like” or “bro”).

A step 220 comprises characterising the one or more actions identified at step 210 relative to one or more corresponding reference actions. This may comprise characterising the identified actions relative to the reference actions to determine one or more behaviour characteristics of the non-users.

Reference actions may comprise reference instances of actions of a same type/classification as the identified actions. A plurality of reference actions may be stored in a database, and a reference action may be selected based upon the identification of the given action. For example, upon identifying an action of a non-user waving at step 210, at step 220 a reference action of waving (i.e. a reference wave) may be fetched from a database for characterisation the identified wave (e.g. comparison to the reference wave to determine that the identified wave is ‘energetic’ relative to the reference wave).

Characterising actions of the non-users relative to corresponding reference actions allows efficiently determining characteristic behaviour traits (e.g. mannerisms) of the non-users so that these can be applied to characters in the virtual environment to enrich the user's interaction with the environment. This can be more efficient than if such traits were to be determined in the abstract without comparison to a reference.

Characterising the identified actions may comprise comparing the identified actions and their characteristics relative to corresponding reference actions. The reference actions may be pre-generated, e.g. based on testing data collected from a plurality of people (e.g. a plurality of people of different accents saying the same word such as “tree”). Alternatively, or in addition, the set of reference actions may be built up over time and new reference actions may be generated based on data received for non-users associated with a particular user. For example, for a user of a certain nationality, audio data captured for corresponding non-users may be stored as reference data indicative of an accent for that nationality.

Comparing the identified actions and reference actions may comprise identifying a closest match amongst one or more reference actions for a given identified action. For example, an accent of a non-user may be determined by identifying a closest match between an identified action of a user saying one or more words and reference pronunciations of those same words each with an associated accent. The closest match in this case may for example be identified using suitable audio processing techniques and/or trained machine learning models. Similarly, the manner in which non-users react to certain events such as a scare scene in the content a user's success in a scenario in the virtual environment may be compared to corresponding reference reactions to identify a closest match. The closest match in this case may for example be identified using suitable video processing techniques to identify closest matching gestures or audio processing techniques to identify closest matching sounds. Once identified, the closest matching reference action may then be used at step 230 to modify an aspect of behaviour of characters in the virtual environment, as described below.

Alternatively, or in addition, comparing the identified actions and reference actions may comprise determining differences between the identified actions and reference actions, which differences may characterise the identified actions. This allows storing only one reference action for each action, and only comparing the action against this one reference action, and so can reduce computational and memory resource usage. For example, an accent of a non-user may be determined by determining differences (e.g. in pitch, speed, tremolo or length of pronunciation of certain letters or syllables) between a reference neutral pronunciation of one or more words and the non-user's pronunciation of those words. Similarly, a characteristic posture or facial expression of a non-user may be determined by determining differences between a reference neutral posture or facial expression and those identified for a given non-user.

In some cases, characterising the identified actions may comprise inputting the identified actions into a machine learning model previously trained on reference actions for various actions. The machine learning model may be trained to output a modification to be made to an aspect of behaviour of characters in the virtual environment at step 230, such as a given behavioural model to be used for the characters. The machine learning model may be supervised and trained on a labelled dataset of reference actions and corresponding modifications to be made, which may for example each have corresponding assigned id's that are output by the machine learning model.

It will be appreciated that the way in which the identified actions are characterised may depend on the type of identified actions. For example, considering characteristic actions, characterising the identified actions may comprise comparing an identified action of walking (or sitting) by a non-user to one or more reference actions for that action to identify a closest matching reference gait (or sitting position). The closest matching reference gait may for example be identified using appropriate gait matching techniques. The closest matching reference gait may then be applied to one or more characters in the virtual environment at step 230.

Considering reactive actions, characterising the identified actions may for example comprise comparing reactions of the non-users to an event (e.g. jump scare scene in the virtual environment) to reference reactions to that event to determine differences between the non-users' reaction and the reference reaction (e.g. the non-users screaming particularly loudly). One or more characters in the virtual environment may then be caused at step 230 to exhibit these distinguishing characteristics (e.g. loud screams) when reacting to corresponding events in the virtual environment.

Considering auxiliary actions, characterising the identified actions may for example comprise comparing the identified auxiliary action with one or more reference auxiliary actions for the identified main action to identify a closest matching reference auxiliary action. For example, for an identified main action of speaking, the identified auxiliary action (e.g. gesturing or tilting of the head) may be compared to various reference auxiliary actions for a main action of speaking to identify the closest match (e.g. closest matching gestures or closest matching tilting of the head).

Considering repetitive actions, characterising the identified actions may comprise determining the frequency with which an identified repetitive actions was repeated. Characterising these actions may then for example comprise comparing the frequency at which an identified action (e.g. use of a given word) was repeated relative to a reference expected frequency of repetition for that action. In other words, the reference action may provide a reference threshold for whether repetition of a given action may be considered a characteristic trait of one or more non-users. This allows accounting for different expected frequencies of repetitions of actions so that actions that are commonly repeated by people which does not necessarily characterise any particular person can be distinguished from actions that are uniquely repeated by a given person or group of people. For example, repeated use of the word “the” may not characterise any particular person. In contrast, repeated use of the word “bro” may be characteristic to a particular person or group of people. Thus, a lower reference threshold may be assigned to the word “bro” than the word “the”.

In some cases, actions may be characterised in dependence on the context in which an identified action was performed by non-users. Considering the context in which identified actions were performed can allow differentiating between characteristic behaviours of the non-users and actions that would typically be expected of the non-users. For example, depending on the context, repetition of a given action may be expected for most non-users or may characterise a particular non-user or group of non-users. For instance, for repetitive actions corresponding to a given word being repeated by a non-user, the wider context in which that word was repeatedly used may be analysed to determine whether its repeated use would have been expected for an average non-user. For example, the entire phrase spoken by a non-user or words spoken by the user or other non-users before or after a given word may be analysed, e.g. using suitable natural language processing techniques, to determine whether repetition of the given word deviates from expectations for that context.

Analysing the context may in some cases comprise considering the content shown in the virtual environment, and/or events in the real and/or virtual environment. For example, repeated gestures of non-users (e.g. turning of the head) may be characterised as tics characteristic to the user if the shown content and/or events are not expected to cause such reactions. In contrast, when scary content is shown (or a jump scare event occurs in the virtual environment, or an object shatters on the ground in the real environment), such reactions may be expected and may not be characterised as tics.

It will be appreciated that a plurality of actions, and/or actions of a plurality of non-users, may be identified at step 210. Accordingly, step 220 may comprise determining an aggregate characterisation of the identified actions relative to the reference actions for the identified actions.

Determining an aggregate characterisation may comprise aggregating the identified actions and/or aggregating characterisations of the identified actions. Aggregating identified actions may for example comprise aggregating the characteristics of the identified actions, for example, averaging or determining the median length of a scream in reaction to a scare scene or of the frequency at which a given word or phrase is repeated. Alternatively, or in addition, aggregating the identified actions may for example comprise determining the most frequent auxiliary action for a given main action amongst a plurality of auxiliary actions. In some cases, aggregating the actions may comprise blending the actions—e.g. blending a plurality of voice inputs from one or more non-users, for later characterisation.

Characterisations may be aggregated in a similar way. For instance, aggregating characterisations of the identified actions may comprise blending of identified accents into a single accent for use with the virtual environment characters at step 230, for example using suitable audio processing techniques. Alternatively, or in addition, a most common accent may be determined amongst the identified accents.

Alternatively, or in addition, characterisations for different identified actions may be matched against a set of references for those actions to identify a general characterisation for the actions—e.g. different ways in which non-users celebrate may be matched against sets of celebratory actions to identify a closest matching set.

Aggregation is considered further below for different combinations of non-users and identified actions.

For example, when a given non-user repeats the same action (e.g. says the same word) a plurality of times, characteristics of the action (e.g. audio characteristics relating to the pronunciation of the word) may be aggregated (e.g. averaged) to provide a single aggregate action that is then characterised relative to reference action(s) for that action as described above. Alternatively, each occurrence of the action may be characterised relative to the reference action(s) separately and the resulting characterisations aggregated—for example, differences between the identified actions and reference action(s) may be aggregated (e.g. averaged), or the most common closest matching reference action may be determined amongst closest matches for each identified action.

In some cases, occurrences of the same action performed by different non-users may be aggregated in a similar way. For example, the aggregate accent of non-users in the real environment of the user may be identified by aggregating characteristics of the pronunciation of a given word by the non-users or by aggregating the respective characterisations of the pronunciation of the word by each non-user.

Alternatively, performances of the same action by a plurality of users may each be treated separately as each non-user may have different mannerisms that can be imported into the virtual environment. For example, a real environment of a user may comprise one non-user that is determined, based on the characterisation at step 220, to have an Italian accent and another non-user that is determined to have a Russian accent. At step 230, either or both of those accents may then be incorporated into the behaviour of characters in the virtual environment, as described later herein.

In turn, when two or more different actions by the same non-user are identified, again these can be characterised separately or together. Characterising the actions separately can allow identifying separate characterising traits of the non-user, for example gesturing while talking and speaking with a particular (e.g. Italian) accent; which traits can then be separately applied to characters in the virtual environment.

In some cases, however, it may be appropriate to characterise a plurality of different actions together relative to a set of reference action(s) for each of the different actions. The set of reference actions may for example relate to predefined profiles for non-user behaviour—e.g. predefined profiles with associated reference actions may be defined for different demographics of non-users, such as for British teenage men or Italian elderly women. The characterising step 220 may then for example comprise identifying a predefined profile that is a closest match for the non-user based on a comparison of identified actions for that non-user and reference actions associated with different profiles. The closest match may for example be determined based on a suitably defined cost function that determines a similarity score between profiles and identified actions based on whether the reference actions for a given profile are present amongst the identified actions and if so the similarity between the reference actions and the identified actions. In this way, for example, the identified actions of a non-user may be characterised as corresponding to particular predefined profile of behaviour, and the behaviour of characters in the virtual environment can then be modified on the basis of this profile at step 230.

Two or more identified actions by two or more non-users may be characterised using similar techniques to those described above. For example, in some cases, each action by each non-user may be characterised separately so that behaviour corresponding to each action can be implemented for the characters in the virtual environment. Alternatively, aggregate characterisations may be determined for multiple actions of one or more of the non-users, using the techniques described above. For example, aggregate characterisations may be determined for occurrences of the same action performed by one or more non-users, or for actions by a given non-user. In some cases, an aggregate characterisation may be determined for all identified actions at step 210, e.g. to determine a predefined profile that is a closest match to the identified actions of the non-users, using techniques described above.

In this way, using one or more of the above techniques, the identified actions may be characterised relative to reference actions for the actions to identify behaviour characteristics of the non-users associated with the identified actions.

A step 230 comprises modifying an aspect of behaviour of one or more characters in the virtual environment that are not controlled by the user, in dependence on the characterisation of the one or more identified actions at step 220. This may comprise modifying an aspect of behaviour of the one or more characters to incorporate the determined behaviour characteristics of the non-users and/or a characterised aspect of the identified actions of the non-users.

The behaviour of the characters may be modified so as to incorporate behaviour characteristics of the non-users identified at step 220 when the characters perform corresponding behaviours—for example, characters may be caused to gesture when they talk based on a characterisation that the non-users gesture while talking. In other words, the way in which a character performs one or more actions can be modified so as to be performed in a manner that is more similar to that of the non-users in the user's environment—and as such the action taken by a character is not determined based upon the non-users, only the manner in which the action is performed.

The characters whose behaviour is modified may comprise computer-controlled characters and/or characters controlled by other users in the virtual environment (e.g. other players in a multiplayer videogame). The computer-controlled characters may comprise any character that is automatically controlled by the computer, including characters that the user can interact with or non-interactive characters (e.g. ‘extras’ that the user is unable to interactive with). In examples where the virtual environment is a videogame virtual environment, the computer-controlled characters may include in-game characters (e.g. football players in a football game, or soldiers in a war game) and/or spectating characters (e.g. the virtual crowd in a football game, or civilians in a war game).

Characters controlled by other users may comprise any character that is controlled by a user other than the user in question, including for example avatars of the other users or further characters controlled by the other users (e.g. troops of the other users).

Modifying an aspect of behaviour of the characters may relate to selection, modification, or generation of appropriate audio and/or animation relating to the behaviour of these characters. It will also be appreciated that the method of FIG. 2 may comprise generating content for display in dependence on the modifying step 230. Generating the content for display may for example comprise generating animation and/or audio corresponding to the modified aspect of behaviour of the one or more characters. Video and/or audio of the characters whose behaviour is modified may be output, e.g. to a television connected to the entertainment device 10.

Modifying an aspect of a character's behaviour may comprise generating new audio and/or animation—in other words, generating audio/animation that would not have otherwise have been generated had the corresponding characterisation not been made at step 220. For example, once the identified actions are characterised as comprising a given tic, appropriate animation and/or audio may be generated displaying that tic, e.g. instantaneously or after a predetermined interval.

Alternatively, or in addition, modifying an aspect of a character's behaviour may comprise modifying an aspect of behaviour of the character to incorporate a characterised aspect of an identified action of a non-user when the character performs a corresponding action. For instance, the relevant behaviour modification may be applied at one or more future occurrences of a corresponding action by the character. For example, upon characterisation that a non-user uses given hand gestures while talking, the next time a character speaks animation corresponding to those hand gestures may be generated.

To demonstrate these two possibilities further, for example, in dependence on a characterisation of the non-users' accent, modifying an aspect of behaviour of one or more characters in the virtual environment may comprise causing those characters to speak with the characterised accent. Appropriate audio and/or animation relating to speaking in that accent may for example be generated (e.g. a character may be caused to say “hello” in the characterised accent); and/or behaviour settings of the characters may be modified such that they speak with that accent in one or more future interactions with the user.

In some cases, a characterisation of non-user actions and/or a corresponding modification (e.g. the behaviour model to be used) for the characters may be associated with the user—e.g. a mapping between the characterisation and/or modification and a user profile for the user may be stored in a database. At runtime of the content for the user, in the current or future sessions, the behaviour of characters in the environment may be modified in accordance with the characterisation and/or modification associated with that user. Thus, it will be appreciated that the non-users may not be present in the real environment of the user at the time the characterisation of their actions is made at step 220 or at the time the characters' behaviour is modified at step 230.

Various further example modifications may be made at step 230.

For example, animation corresponding to a modified gait and/or facial expressions of one or more characters in the virtual environment may be output in dependence on the characterisation of the gait and/or facial expressions of non-users in the real environment of the user.

Alternatively, or in addition, in dependence on the characterisation of an identified reactive action to a given event, animation and/or audio relating to corresponding reactions of the characters may be generated upon occurrence of a relevant event in the virtual environment. For example, a characterisation may be made at step 220 that non-users react to ‘success’ events (e.g. the user succeeding in a scenario in the virtual environment)—i.e. celebrate—by jumping up and down and screaming. Subsequently, upon a success event occurring in the virtual environment (e.g. soldiers winning a battle), characters (e.g. the soldiers) may be caused to celebrate in a corresponding manner—e.g. by generating animation relating to the characters jumping up and down and audio relating to the characters shouting.

Alternatively, or in addition, in dependence on the characterisation of an identified auxiliary action, animation and/or audio relating to the auxiliary action may be generated when a character performs the corresponding main action. For example, based on a characterisation that non-users tilt their head while talking, animation corresponding to a character tilting their head may be generated when the character is talking in the virtual environment.

Alternatively, or in addition, characters in the virtual environment may be caused to perform characterised repetitive actions of the non-users. The characters may be caused to perform the repetitive actions at the characterised frequency of repetition of these actions. For example, animation relating to a character exhibiting a given tic may be generated, or audio relating to a character saying a given repetitive phrase may be generated.

It will be appreciated that the audio and/or animation may be presented in the appropriate context depending on the corresponding modified behaviour. For example, animation and/or audio corresponding to a characterisation of an action may be presented at random times (e.g. for animation/audio relating to tics), or during, before, or after specific actions of the characters or events in the virtual environment (e.g. for animation/audio relating to characterised reactive actions).

The modification of character behaviour may be implemented in several different ways. In one or more examples, an application (e.g. videogame application) generating the virtual environment for display to the user may be configured for making the required modifications in advance such that the application can make the modifications in real time, without requiring changes to the underlying code (e.g. to a games engine of a videogame). This allows modifying the character behaviour on the client side only—thus providing an efficient mechanism for personalising the virtual environment for a wide range of users at their respective client devices.

For example, an application may be preconfigured to modify character behaviour by selecting an appropriate behaviour model for the characters, and/or by modifying one or more behaviour settings for the characters.

Considering selecting a behaviour model, the modifying step 230 may comprise selecting one of a plurality of behaviour models for the one or more characters in dependence on the characterisation of the one or more identified actions. A behaviour model may define how animation and/or audio is to be generated for one or more given behaviours. Behaviour models may be pre-generated for a range of behaviours that may need to be implemented, for example using suitable audio and/or animation generation techniques. Separate behaviour models may be pre-generated for different behaviours—for example, separate behaviour models may be generated for different gestures to be performed by a character. Alternatively, or in addition, more general behaviour models may be pre-generated that encompass several different behaviours—e.g. a behaviour model for a character to speak quickly, with a given accent, while also gesturing while speaking, may be pre-generated and used instead of separate models for each of those behaviours. In some cases, general behaviour models may be defined for demographic groups of non-users.

In this way behaviour models can be used to implement various modifications to characters' behaviour in the virtual environment. For instance, behaviour models may define how to implement animation relating to different gestures (e.g. waving hands or jumping), audio relating to different sounds (e.g. cheering and booing). In some cases, behaviour models may define how to modulate other existing (e.g. default) behaviour of characters in dependence on the characterisation at step 220. For example, behaviour models may define how to adapt the audio output for a given character in dependence on a characterised accent of a non-user—e.g. a behaviour model may be a filter to be applied to the sound output by a character to implement the accent. Alternatively, or in addition, behaviour models may define how to incorporate words or phrases characterised as characteristically repetitive for a non-user (e.g. a user using a given term characteristically frequently) into the default speech of a character—e.g. language models may be used to determine the appropriate points in the speech at which the repetitive words or phrases can be inserted.

Selecting one or more relevant behaviour models for use with a character in the virtual environment may comprise using a machine learning model trained to select one or more behaviour models based on an input characterisation of the identified actions. The machine learning model may be trained on a labelled dataset of identified action characterisations and behaviour models, so as to classify input characterisations into one or more output behaviour models. Alternatively, or in addition, as discussed above, the behaviour model may be selected using a machine learning model trained to select behaviour models based on input data relating to the identified actions (e.g. based on video of a non-user performing a gesture, or an audio recording of a non-user).

Alternatively, or in addition, the selection of one or more relevant behaviour models may be done in dependence on a predefined mapping between identified action characterisations made at step 220 and behaviour models for use in modifying character behaviour at step 230. For example, ids may be assigned to each characterisation and behaviour model and mappings between the respective ids may be stored in a database. For instance, each possible characterised accent may be assigned to a respective behaviour model for implementing that accent for a character. Similarly, mappings may be provided between characterised gestures and behaviour models for implementing those gestures. It will be appreciated that separate behaviour models may be provided for each character to implement different behaviours for that specific character. It will also be appreciated that a plurality of behaviour models may be applied to a given character (e.g. which may be caused to have a given tic and also react to scare events in a given manner).

Considering modifying behaviour settings, alternatively or in addition to selecting given behaviour models, one or more settings of those models (and/or of any other, e.g. default, behaviour models used for the characters) may be modified in dependence on the characterisation of the identified actions. For example, in dependence on a characterisation of a voice or accent of a non-user, audio output settings for a character (e.g. defining their pitch or tone of voice) may be modified. Similarly to the selection of behaviour models, behaviour setting may be modified based on predetermined mappings between action characterisations and behaviour setting or modifications, and/or using a machine learning model trained to map between the two parameters.

Character behaviour may be modified in substantially the same way for individual and aggregate characterisation of the identified actions determined at step 220. For example, one or more behaviour models for a character may be selected in dependence on an aggregate predefined profile of behaviour determined for the non-users at step 220.

In cases where multiple characterisations of a given type are determined at step 220 (e.g. where multiple accents are identified), modifying the behaviour of the characters may comprise modifying the behaviour of one or more characters based on one or more of the characterisations. Modifying the behaviour may for example comprise applying each of the characterisations to different characters, applying a subset of the characterisations to the characters, or applying an aggregated characterisation based on the characterisations. For example, where a plurality of accents are identified based on the characterisation, the behaviour of one or more characters may be modified to exhibit each of the accents, and/or a subset of identified accents may be selected (e.g. at random, or based on how many non-users are determined to have each accent) for use by the characters, and/or the plurality of

The one more characters whose behaviour is modified at step 230 may be selected in dependence on various parameters, such as one or more of: one or more properties of the characters, a gaze direction of the user, an application (e.g. videogame) associated with the virtual environment, and/or a user input.

Considering properties of the characters, for example, the characters whose behaviour is modified may be selected in dependence on their stance relative to the user in a scenario in the virtual environment (e.g. in a videogame scenario). For example, only the behaviour of characters that are friendly or neutral to the user may be modified at step 230, while the behaviour of characters that are enemies of the user may not be modified. This can improve the user experience, and for example help to avoid importing behaviour traits of real people the user interacts with to the user's enemies in the virtual environment (e.g. the gestures of a user's grandparent to an enemy zombie in a videogame).

In some cases, the behaviour modification itself may depend on a character's stance relative to the user. For example, as described above, the behaviour of characters that are friendly or neutral to the user may be modified to incorporate determined behaviour characteristics of the non-users in the user's real environment. In turn, the behaviour of characters that are in opposition to the user (e.g. that are enemies of the user) may be modified to incorporate behaviours contrasting with the determined behaviour characteristics of the non-users. For example, a predetermined mapping may be provided between contrasting behaviour modifications—e.g. between a first behaviour model for gesturing vividly while talking, and a second behaviour model for talking with a stern facial expression and subdued body language. The relevant contrasting behaviour (e.g. behaviour model) may then applied to characters that are in opposition to the user. This allows further enriching the user's virtual environment and making it more intuitive as characters in opposition to the user may be caused to seem less relatable and be easier to identify for the user.

Alternatively, or in addition, the characters whose behaviour is modified may be selected in dependence on a location of the characters in the virtual environment. For example, characters that are within a predetermined distance of the user's character in the virtual environment may be selected. This allows improving the balance between enriching the user's experience and computational resource usage as the behaviour of characters nearby the user's avatar can be modified to provide an improved user experience while not using up resources to modify the behaviour of more distant characters. Considering the distance between a character and the user's avatar can also allow personalising a multi-user virtual environment (e.g. that of a multiplayer videogame) for each user, even if the environment is run centrally for all users—for example, the behaviour of characters neighbouring a first user may be modified in dependence on characterisations of actions of non-users in the first user's real environment, while the behaviour of characters neighbouring a different second user may be modified in dependence on characterisations of actions of non-users in the second user's real environment.

Considering user gaze, the characters may be selected in dependence on the position of the user's gaze (e.g. as determined using a gaze tracker in the HMD 120). For example, the characters within a predetermined distance (e.g. in pixels) from the current user gaze location on the image may be selected. This can allow further improving the user's experience of the virtual environment by modifying the behaviour of characters that the user is currently looking at and paying attention to.

In some cases, the one or more characters may be selected by an operator (e.g. a game developer), and/or may be selected automatically. For example, the characters may be selected based on historical data relating to interaction of a plurality of users with the virtual environment. For instance, the characters may be selected as the characters that users have historically most interacted with (e.g. interacted with most frequently, for longest periods of time, and/or have approached (i.e. have been within a predetermined distance of) most frequently), or characters that users have historically most frequently gazed at (e.g. as determined using HMDs associated with the historical users).

In some cases, a prediction of interactions with the content of the particular user interacting with the virtual environment may be made based on the historical data relating to users' interactions using a trained predictive model. Characters may then be selected for the particular user based on the predicted interaction-for example, characters for which the probability of user interaction with a given character is above predetermined threshold may be selected.

Alternatively, or in addition, the characters may be selected based on user input. A user may, for example, select the characters whose behaviour should be modified, e.g. during an initial configuration, or application load, step. For example, the user may select one or more characters in the virtual environment the behaviour of which they wish to be modified. When a selected character is then presented to the user (e.g. the character is shown in a displayed image or is providing an audio output), a modification to its behaviour may be made as discussed herein. In some cases, the user may select a set of characters whose behaviour is to be modified. The set of objects may, for example, be defined by character classifications (e.g. wizards, knights, etc.). The user may select the characters, or sets of characters, in a variety of ways, such as using a dropdown menu, a search box, or by selecting (e.g. clicking) characters displayed in a configuration image. User selections may be stored so that they can be re-used between instances of the virtual environment and/or between users.

It will be appreciated that once a character is selected for modifying the behaviour thereof, the behaviour of that character may be modified throughout the user's interaction with the virtual environment to provide a consistent experience to the user.

It will also be appreciated that the behaviour of only a subset of characters not controlled by the user in the virtual environment may be modified. This can allow enriching the user's experience by importing behaviours from their real environment into the virtual environment, while not altering the default design for interactions in the environment (e.g. while not detracting excessively from the storyline of a videogame). In some cases (e.g. if the number of selected characters exceeds a predetermined threshold), a selection of the characters using the parameters discussed above may be further filtered in order to reduce their number. For example, the behaviour of every one in n (e.g. one in five or ten) characters may be selected for behaviour modification. The filtered subset may be selected at random or based on an empirically determined priority ranking of characters (e.g. which defines in what order characters' behaviour should be modified to provide an improved user experience). The priority ranking may for example be determined and set by an operator (e.g. developer of a game).

In some cases, the modifications to character behaviour at step 230 may be made in dependence on the application associated with the virtual environment, and/or the current displayed content. This may for example be implemented using a machine learning model trained to adapt the behaviour modification (e.g. the settings of a selected behaviour model) in dependence on the application associated with the virtual environment, and/or the current displayed content. For example, the modifications may be adapted (e.g. by selecting appropriate behaviour models, and/or adjusting the settings of behaviour models) in dependence on properties of the application, such as its genre. For instance, for videogame virtual environments, different behaviour models may be used to implement gesturing while talking in a cartoon game (where more exaggerated gesturing may be used) and in horror games (where more subdued gesturing may be used). Similarly, the timing of the modifications to character behaviour may be controlled in dependence on the current displayed content so as to not interfere with the user's normal experience of the virtual environment. For example, where characters are caused to exhibit tics this may be controlled to occur at times where it would not distract the user from their interaction with the environment (e.g. during cut-scenes, as opposed to fight scenes in a videogame).

It will be appreciated that one or more of the characters whose behaviour is modified may not be human and/or humanoid (i.e. may be non-human or non-humanoid). In such cases, step 230 may comprise determining a modification to an aspect of behaviour of a human character in dependence on the characterisation of the identified inputs, translating the modification in dependence on one or more properties of the non-human character, and applying the modification to the non-human/non-humanoid character. In this way, the present behaviour modification techniques may be applied more broadly to characters that are not necessarily the same in appearance as humans.

The modification to an aspect of behaviour of a human character may be determined in dependence on the characterisation of the identified inputs using one or more of the above-described techniques. The translation to the modification may then for example be determined using a machine learning model trained to map human behaviour modifications to behaviour modifications for a non-human character in dependence on properties of the character. Example relevant properties of the non-human character may, e.g., comprise numbers and shapes of various body parts (e.g. number of legs, eyes etc.). In this way, for example, non-human characters who have more than two arms may be caused to gesture while talking.

Alternatively, or in addition, behaviour models may be pre-generated for different non-human characters and these may be used in place of other ‘human-directed’ behaviour models.

It will be appreciated that the virtual environment augmentation method described herein may be implemented locally (e.g. on an entertainment device 10 of a user). Alternatively, or in addition the method may be at least partially implemented on a remote computing device (e.g. a cloud server) to reduce the computational load on the local device.

In either case, in one or more examples, step 210 of identifying non-user actions may be performed locally in order to preserve non-user privacy. Once the actions of non-users are identified at step 210, the captured data relating to the non-users (e.g. video or audio data of the non-users) may be discarded to protect their privacy. In some cases, one or more indicators associated with the identified actions (e.g. an ID associated with a given gesture such as pumping fist) may be generated at step 210 for use in characterising the actions at step 220. In this way, the privacy of non-users may be further protected as only indicators of their actions are used in further steps of the process as opposed to actual data showing the actions (e.g. audio or video data).

It will be appreciated that whilst the above description has used a videogame as an example, the invention is not limited to any particular video game, or to videogames per se. For example, the present disclosure can be applied to any other virtual environment comprising characters not controlled by a user, including those provided as part of a virtual or augmented reality system. For example, a virtual environment relating to safety training material may be modified in accordance with the techniques of the present disclosure to make the training more relatable to users (where the characters exhibit behaviour determined based on actions of people in the user's real environment) and thus more effective for the users.

Referring back to FIG. 2, in a summary embodiment of the present invention a method for augmenting a virtual environment comprises the following steps.

A step 210 comprises identifying one or more actions of one or more non-users in a real environment of a user who is interacting with a virtual environment, in dependence on data relating to the non-users captured using one or more sensors, as described elsewhere herein.

A step 220 comprises characterising the one or more identified actions of the non-users relative to one or more corresponding reference actions, as described elsewhere herein.

A step 230 comprises modifying an aspect of behaviour of one or more characters in the virtual environment that are not controlled by the user, in dependence on the characterisation of the one or more identified actions of the non-users, as described elsewhere herein.

It will be apparent to a person skilled in the art that variations in the above method corresponding to operation of the various embodiments of the method and/or apparatus as described and claimed herein are considered within the scope of the present disclosure, including but not limited to that:
reference actions comprise reference instances of actions of a same type/classification as the identified actions, as described elsewhere herein;
the characterising step 220 comprises comparing one or more parameters of identified actions to one or more parameters of the reference actions, as described elsewhere herein;
in this case, optionally comparing comprises identifying a closest matching reference action for an identified action, and/or determining differences between an identified action and a reference action, as described elsewhere herein;
the characterising step 220 comprises characterising the identified actions relative to the reference actions to determine one or more behaviour characteristics of the non-users, as described elsewhere herein;
the modifying step 230 comprises modifying an aspect of behaviour of the one or more characters to incorporate the determined behaviour characteristics of the non-users, as described elsewhere herein;
the modifying step 230 comprises modifying an aspect of behaviour of the one or more characters to incorporate a characterised aspect of the identified actions of the non-users, as described elsewhere herein;
the identifying step 210 comprises identifying a reaction of a non-user to an event in the virtual and/or real environment, as described elsewhere herein;
the identifying step 210 comprises identifying a first action of a non-user that is performed at least partially simultaneously with a second action of the non-user, as described elsewhere herein;
the identifying step 210 comprises identifying an action of a non-user that is repeated a plurality of times by the non-user, as described elsewhere herein;
the actions comprise behaviours of the non-users, as described elsewhere herein;
the actions comprise speech and/or movement of the non-users, as described elsewhere herein;
the one or more actions comprise one or more selected from the list consisting of: vocalisations of the one or more non-users; gestures of the one or more non-users; facial expressions of the one or more non-users; postures of the one or more non-users; and words from the one or more non-users, as described elsewhere herein;
the one or more sensors comprise one or more image sensors and/or one or more audio sensors, as described elsewhere herein;
the identified actions comprise a plurality of identified actions; and the characterising step 220 comprises determining an aggregate characterisation of the identified actions relative to the corresponding reference actions, as described elsewhere herein;
in this case, optionally determining an aggregate characterisation comprises aggregating the identified actions and/or aggregating characterisations of the identified actions, as described elsewhere herein;
the modifying step 230 comprises selecting one of a plurality of behaviour models for the one or more characters in dependence on the characterisation of the one or more identified actions, as described elsewhere herein;
the modifying step 230 is performed further in dependence on an application associated with the virtual environment and/or current displayed content, as described elsewhere herein;
the method further comprises selecting the one or more characters in dependence on one or more selected from the list consisting of: one or more properties of the characters, a gaze direction of the user, or a user input, as described elsewhere herein;
in this case, optionally selecting the one or more characters comprises selecting one or more characters that are within a predetermined distance of the user's character in the virtual environment, as described elsewhere herein;
the identifying step 210 further comprises identifying one or more actions of one or more non-users in real environments of one or more further users interacting with the virtual environment, in dependence on data relating to the respective non-users captured using one or more respective sensors, as described elsewhere herein;
in this case, optionally the one or more further users are selected in dependence on one or more properties of the user, as described elsewhere herein;
the method further comprises generating content for display in dependence on the modifying step, as described elsewhere herein;
in this case, optionally generating content for display comprises generating animation and/or audio corresponding to the modified aspect of behaviour of one or more characters, as described elsewhere herein;
the one or more characters comprise at least one non-human character, and wherein the modifying step comprises determining a modification to an aspect of behaviour of a human character in dependence on the characterisation of the identified inputs, translating the modification in dependence on one or more properties of the non-human character, and applying the modification to the non-human character, as described elsewhere herein;
the modifying step 230 comprises modifying an aspect of behaviour of a character to incorporate a characterised aspect of an identified action of a non-user when the character performs a corresponding action, as described elsewhere herein;
the virtual environment is a video game environment, as described elsewhere herein;
the method further comprises capturing data relating to the non-users using one or more sensors, as described elsewhere herein; and
the modifying step 230 comprises modifying an aspect of behaviour of one or more characters that are within a predetermined distance of the user's character in the virtual environment, as described elsewhere herein.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

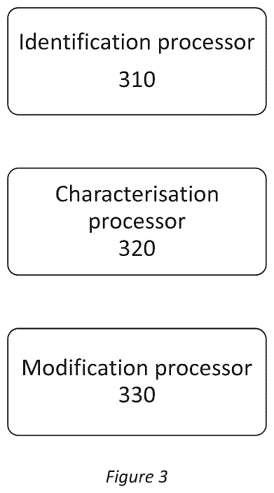

Referring to FIG. 3, in a summary embodiment of the present invention, a system for augmenting a virtual environment may comprise the following:

An identification processor 310 configured (for example by suitable software instruction) to identify one or more actions of one or more non-users in a real environment of a user who is interacting with a virtual environment, in dependence on data relating to the non-users captured using one or more sensors, as described elsewhere herein.

A characterisation processor 320 configured (for example by suitable software instruction) to characterise the one or more identified actions of the non-users relative to one or more corresponding reference actions, as described elsewhere herein.

A modification processor 330 configured (for example by suitable software instruction) to modify an aspect of behaviour of one or more characters in the virtual environment that are not controlled by the user, in dependence on the characterisation of the one or more identified actions of the non-users, as described elsewhere herein.

These processors 310-330 may, for example, be implemented by the CPU 20 of the entertainment system 10. Of course, it will be appreciated that the functionality of these processors may be realised by any suitable number of processors located at any suitable number of devices and any suitable number of devices as appropriate rather than requiring a one-to-one mapping between the functionality and a device or processor.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method for augmenting a virtual environment, the method comprising:
identifying one or more actions of one or more non-users in a real environment of a user who is interacting with a virtual environment, in dependence on data relating to the non-users captured using one or more sensors;
characterising the one or more identified actions of the non-users relative to one or more corresponding reference actions; and
modifying an aspect of behaviour of one or more characters in the virtual environment that are not controlled by the user, in dependence on the characterisation of the one or more identified actions of the non-users.

2. The method of claim 1, wherein the identifying step comprises identifying a reaction of a non-user to an event in the virtual and/or real environment.

3. The method of claim 1, wherein the identifying step comprises identifying a first action of a non-user that is performed at least partially simultaneously with a second action of the non-user.

4. The method of claim 1, wherein the identifying step comprises identifying an action of a non-user that is repeated a plurality of times by the non-user.

5. The method of claim 1, wherein the one or more actions comprise one or more selected from the list consisting of:
a. vocalisations of the one or more non-users;
b. gestures of the one or more non-users;
c. facial expressions of the one or more non-users;
d. postures of the one or more non-users; and
e. words from the one or more non-users.

6. The method of claim 1, wherein the one or more sensors comprise one or more image sensors and/or one or more audio sensors.

7. The method of claim 1, wherein the identified actions comprise a plurality of identified actions; and wherein the characterising step comprises determining an aggregate characterisation of the identified actions relative to the corresponding reference actions.

8. The method of claim 1, wherein the modifying step comprises selecting one of a plurality of behaviour models for the one or more characters in dependence on the characterisation of the one or more identified actions.

9. The method of claim 1, wherein the modifying step is performed further in dependence on an application associated with the virtual environment and/or current displayed content.

10. The method of claim 1, further comprising selecting the one or more characters in dependence on one or more selected from the list consisting of: one or more properties of the characters, a gaze direction of the user, or a user input.

11. The method of claim 10, wherein selecting the one or more characters comprises selecting one or more characters that are within a predetermined distance of the user's character in the virtual environment.

12. The method of claim 1, wherein the identifying step further comprises identifying one or more actions of one or more non-users in real environments of one or more further users interacting with the virtual environment, in dependence on data relating to the respective non-users captured using one or more respective sensors; wherein the one or more further users are selected in dependence on one or more properties of the user.

13. The method of claim 1, further comprising generating content for display in dependence on the modifying step, wherein generating content for display comprises generating animation and/or audio corresponding to the modified aspect of behaviour of one or more characters.

14. A computer program comprising computer executable instructions adapted to cause a computer system to perform a method for augmenting a virtual environment, the method comprising:
identifying one or more actions of one or more non-users in a real environment of a user who is interacting with a virtual environment, in dependence on data relating to the non-users captured using one or more sensors;
characterising the one or more identified actions of the non-users relative to one or more corresponding reference actions; and
modifying an aspect of behaviour of one or more characters in the virtual environment that are not controlled by the user, in dependence on the characterisation of the one or more identified actions of the non-users.

15. A system for augmenting a virtual environment, the method comprising:
an identification processor configured to identify one or more actions of one or more non-users in a real environment of a user who is interacting with a virtual environment, in dependence on data relating to the non-users captured using one or more sensors;
a characterisation processor configured to characterise the one or more identified actions of the non-users relative to one or more corresponding reference actions; and
a modification processor configured to modify an aspect of behaviour of one or more characters in the virtual environment that are not controlled by the user, in dependence on the characterisation of the one or more identified actions of the non-users.
